(19) United States
(12) Patent Application Publication
(10) Pub. No.: US 2022/0250546 A1
(43) Pub. Date: Aug. 11, 2022

(54) REARVIEW MIRROR

(71) Applicant: Paul William Scott, Flower Mound, TX (US)

(72) Inventor: Paul William Scott, Flower Mound, TX (US)

(21) Appl. No.: 17/665,747

(22) Filed: Feb. 7, 2022

Related U.S. Application Data
(60) Provisional application No. 63/146,674, filed on Feb. 7, 2021.

(51) Int. Cl. B60R 1/06; B60R 1/08

(52) U.S. Cl. CPC B60R 1/06; B60R 1/082

(57) ABSTRACT

A rearview mirror mountable on an electric scooter or similar devices provides visibility for users of the devices. The rearview mirror comprises a mirror with a curved surface and a mounting structure configured to mount the mirror above a steering shaft of the vehicle. The mounting structure is configured to connect to the vehicle around the steering shaft of the vehicle and the mirror is connected to the mounting structure such that the rearview mirror is located above the steering shaft.

### CROSS-REFERENCE TO RELATED APPLICATION

This application claims priority to U.S. Provisional Application No. 63/146,674 filed on Feb. 7, 2021.

### FIELD OF THE INVENTION

The present invention is a rearview mirror which can be mounted on an electric scooter or similar devices (e.g., vehicle) and provides a solution to the problem of limited visibility for users of an electric scooter or similar devices. The core components of the invention are a mirror with a curved surface and a mounting structure configured to mount the mirror above a steering shaft of the vehicle. Generally speaking, the components are configured as follows: the mounting structure is configured to connect to the vehicle around the steering shaft of the vehicle and the mirror is connected to the mounting structure such that the rearview mirror is located above the steering shaft.

### BACKGROUND

Various forms of rearview mirrors exist for various types of vehicles. Most types of rearview mirrors are mounted to the sides of the vehicle. Some rearview mirrors are designed to be mounted centrally such as on a windscreen of a motorcycle. However, not all vehicles have structures extending above a steering mechanism (like a windscreen above handlebars of a motorcycle) where a rearview mirror can be mounted. Moreover, for vehicles usually smaller than motorcycles, such as an electric scooter, power wheelchair, and gas scooter, mounting a rearview mirror above a steering mechanism may be more challenging due to their relatively small sizes around the steering mechanism.

### SUMMARY OF THE INVENTION

The disclosed device is unique when compared with other known devices and solutions because it provides a structure for mounting a mirror above a steering shaft of a vehicle.

The disclosed device is unique in that it is structurally different from other known devices or solutions. More specifically, the device is unique due to the presence of: (1) a mounting structure for mounting a mirror above a steering shaft of a vehicle; and (2) the mounting structure is configured to attach around a steering shaft of the vehicle.

### BRIEF DESCRIPTION OF DRAWINGS

FIG. 1 shows an example side view of a vehicle with a first rearview mirror mount attached.

FIG. 2 shows an example front view of the first rearview mirror mount.

FIG. 3 shows an example top view of the first rearview mirror mount.

FIG. 4 shows an example front view of the first rearview mirror mount attached around the steering shaft of the vehicle.

FIG. 5 shows an example side view of the vehicle with a second rearview mirror mount attached via an attachment.

FIG. 6 shows an example front view of the second rearview mirror mount.

FIG. 7 shows an example front view of the second rearview mirror mount attached to the attachment which is attached to the steering shaft of the vehicle.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose limits include both numbers. For example, “25 to 100” means a range whose lower limit is 25 and upper limit is 100 and includes both 25 and 100.

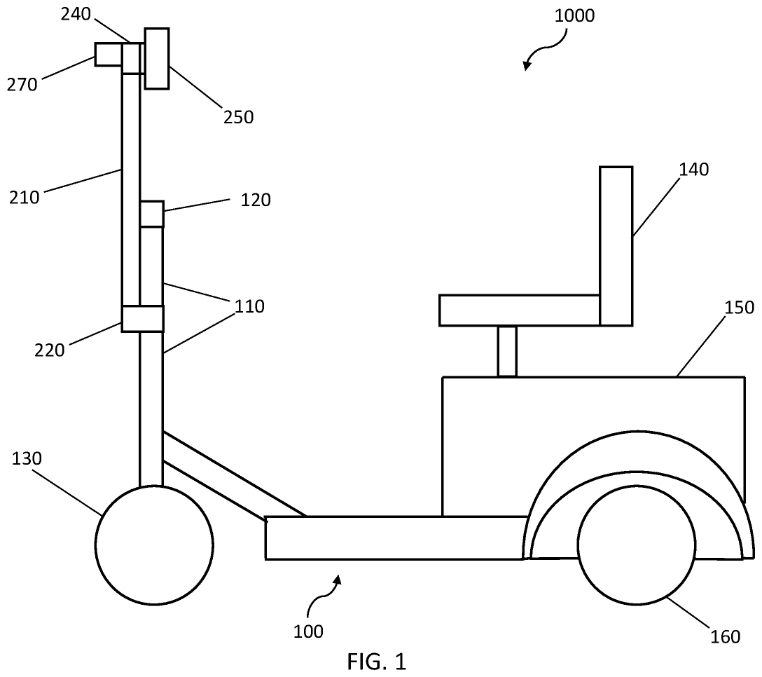

FIG. 1 shows an example side view of a vehicle 100 with a first rearview mirror mount 200 attached to the vehicle 100. The vehicle 100 with the rearview mirror mount 200 attached may be referred to as a vehicle system 1000. The vehicle 100 may be an electric scooter, power wheelchair, gas scooter, or other similar device. The depicted example is an electric wheelchair, however, other vehicles could be substituted for the depicted example. The vehicle 100 may include a steering shaft 110, steering mechanism 120, a front wheel 130, seat 140, motor compartment 150 and rear wheels 160. The steering shaft 110 may connect the steering mechanism 120 to the front wheel 130 such that a user of the vehicle 100 can change a direction of the front wheel and affect the direction the vehicle 100 travels. The steering shaft 110 may extend perpendicular upwardly from the ground level or may be slanted toward the seat 140. One front wheel 130 (i.e., a three-wheel configuration) or two front wheels 130 (i.e. a four wheel configuration) may be used. The seat 140 may allow a user to comfortably sit on the vehicle 100 while being able to reach the steering mechanism 120. The seat 140 may be on top of the motor compartment 150. An electric motor or gas motor or other similar power source (not shown) may be mounted in the motor compartment 150 and connected to the rear wheels 160 to provide power to move the vehicle 100. Controls for the motor (not shown) may include foot pedals, controls on the motor compartment, controls on the steering mechanism, etc.

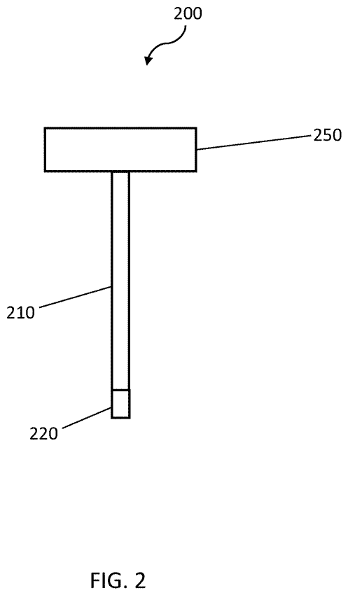

FIG. 2 shows an example front view of the first rearview mirror mount 200. The first rearview mirror mount 200 may include a shaft 210, connector 220, mount 240, rearview mirror 250, and auxiliary attachment 270 (shown in FIG. 1). The shaft 210 may be made of metal, plastic, or other durable material and extend about 18 inches to three feet in length. The length of the shaft 210 may be adjustable in some example embodiments. The connector 220 may include one or more metal or plastic brackets, clamps, screws, nuts, springs, braces, and other similar devices suitable for connecting the shaft 210 to the steering shaft 110. The shaft 210 and the connector 220 may be connected together by welding, clamping the connector 210 on the perimeter of the shaft 210, or screwing the connector 220 on the shaft 210, or any other methods known to a person having ordinary skill in the art.

The mount 240, as shown in FIG. 1, may attach the rearview mirror 250 to the shaft 210. The mount 240 may be on an opposite end of the shaft 210 to the connector 220. The mount 240 may be made of similar materials as the shaft 210 and connector 220. The rearview mirror 250 may include a reflective surface 252. The reflective surface 252 may include a metal and/or glass material (or other material suitable for reflecting a clear image). The connector 220 and the rearview mirror 250 may extend away from the shaft 210 in the same direction so that the rearview mirror 250 is above the steering shaft 110, when the first rearview mirror mount 200 is connected to the vehicle (i.e., connected to the steering shaft 110). A height of the rearview mirror 250 may be about at chest or neck level of a user of the vehicle 100 so that the first rearview mirror mount 200 does not obstruct the vision of the user directly ahead. The rearview mirror 250 may be directly over (i.e., above and aligned with), above and in front of, or above and behind the steering shaft 110.

One or more auxiliary attachments 270 may be attached to the shaft 210 or mount 240 and may include a light, horn, camera, sensor, or other devices. The auxiliary attachments 270 may increase the utility of the vehicle without encumbering the steering mechanism 120.

The rearview mirror 250 may have a substantially rectangular shape (when viewed from the front) and may extend out in a direction perpendicular to the length (greatest or longest dimension) of the shaft 210. Other shapes, such as oval, crescent, and square are also possible.

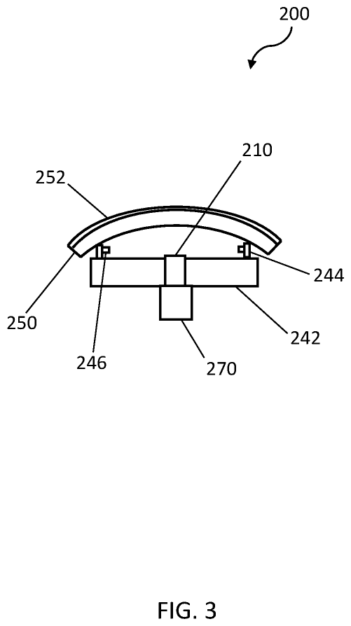

FIG. 3 shows an example top view of the first rearview mirror mount 200. The mount 240 may extend out in the direction perpendicular to the length (longest dimension) of the shaft 210. The mount 240 may include a crossbar 242, connection extensions 244, and adjustment lock 246 as shown in FIG.3. The crossbar 242 may extend out in a direction perpendicular to the length (longest dimension) of the shaft 210. The crossbar 242 may pass through or over the shaft 210, or alternatively rest on the shaft 210 with screws, brackets, and other similar devices connecting the crossbar 242 and the shaft 210. The connection extensions 244 may extend from the crossbar 242 and in a direction perpendicular to the length (longest dimension) of the crossbar 242 and perpendicular to the length of the shaft 210. The connection extension 244 may connect the rearview mirror 250 to the extension bar 242. The adjustment lock 246 may include a screw that, when tightened, fixes the tilt of the rearview mirror 250 and when loosened allows a tilt of the rearview mirror 250 to be adjusted. Alternatively, the adjustment lock 246 may be a pin or other similar device that provides a friction force to maintain the tilt of the rearview mirror 250 during normal operation of the vehicle 100 (i.e., the tilt is maintained when the vehicle 100 moves and goes over bumps and the like) but can be adjusted with a manual force by a user. Thus, the rearview mirror 250 may be adjusted according to user preference, for users of different heights, and to compensate for different angles of the steering shaft 110 for different vehicles 100. The reflective surface 252 of the rearview mirror 250 may be curved such that a user of the vehicle 100 may view about 180 degrees in the plane of motion of the vehicle 100 in the rearview mirror 250 when the steering mechanism 120 is straight. The rearview mirror 250 may be substantially flat (i.e., not curved) in the vertical direction (from the perspective of FIG. 1) or may be curved in order to provide a wide view to the user.

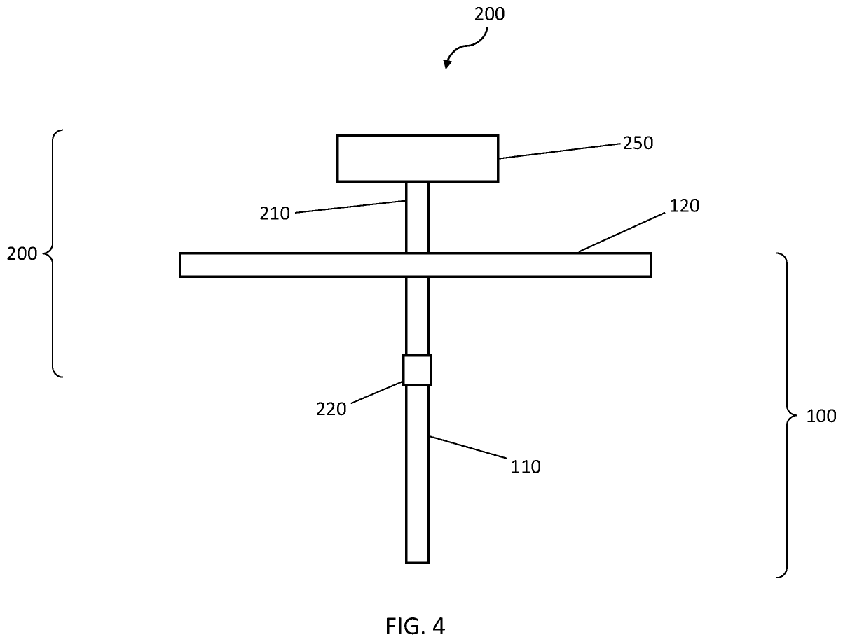

FIG. 4 shows an example front view of the first rearview mirror mount 200 attached to the steering shaft 110 of the vehicle 100 as shown in FIG. 1. FIG. 4 is from the perspective of a user of the vehicle 100 when seated on the seat 140. The steering mechanism 120 may include handlebars which extend in a direction perpendicular to the length (longest dimension) of the steering shaft 110.

The connector 220 may wrap around the steering shaft 110 and be held in place by friction so that the steering shaft 110 does not need any additional holes and is not damaged by attaching the connector 220. In order to be held in place by friction, the connector 220 may be made out of elastic material and shaped to exert elastic force toward the surface of the steering shaft 110. For example, if the steering shaft 110 is cylindrical in shape, the connector 220 may be a C-shaped clip that has an inner diameter slightly smaller than the outer diameter of the steering shaft 110 and an opening directed toward the steering shaft 110, and the connector 220 may be made of metal, plastic, or other flexible material. When the user pushes the shaft 210 around the connector 220 against the steering shaft 110, the opening of the connector opening broadens to receive the steering shaft 110, and the connector 220 snaps on and locks around the steering shaft 110. In some example embodiments, the connector 220 has a length of about 15 cm along the length (greatest or longest dimension) of the shaft 210. If the steering shaft 110 has a square or rectangular cross-section, the connector 220 may have a square or rectangle clip with an opening toward the steering shaft 110. In some other embodiments, the connector 220 has a length of about 30 cm along the length of the shaft 210. In some example embodiments, the connector 220 may include a latch clamp that tightly wraps around the steering shaft 110 when the latch closes. In some example embodiments, the connector 220 may wrap halfway or three quarters of the way around the steering shaft 110.

As shown in FIGS. 1 and 4, the shaft 210 and the connector 220 may be disposed behind the steering shaft 110 when seen from the user seated on the seat 140. The rearview mirror 250 may be substantially above the steering shaft 110 as shown in FIGS. 1 and 4. Alternatively, the rearview mirror 250 may protrude further toward the user seated on the seat 140, or the rearview mirror 250 may recede from the position of the steering shaft 110 as seen from the user seated on the seat 140. Still alternatively, the relative distance of the rearview mirror 250 from the user seated on the seat 140 with respect to the steering shaft 110 may be manually adjusted by the user. In some example embodiments of the first rearview mirror mount 200, the connection extensions 244 and the adjustment locks 246 shown in FIG. 3 may provide for distance adjustment in addition to angle adjustment.

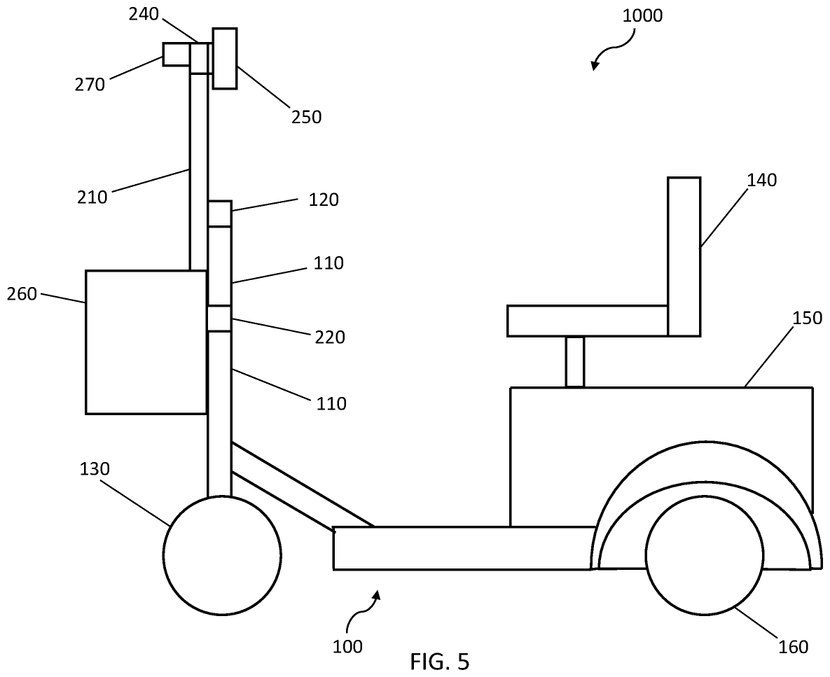

FIG. 5 shows an example side view of the vehicle 100 with a second rearview mirror mount 200 attached via an attachment 260. The second rearview mirror mount 200 may be the same as the first rearview mirror mount 100 except for including the attachment 260 and the hardware (discussed below) used to connect the shaft 210 to the attachment 260. The attachment 260 may be a basket or other accessory for the vehicle 100. The shaft 210 may extend into the attachment 260. The attachment 260 may be attached to the steering shaft 110 via the connector 220 in the same manner and with the same hardware as discussed with regards to FIG. 1. The shaft 210 may be connected to the attachment 260 via screws (as shown and described below) or other similar devices. Accordingly, the shaft 210 may be connected to the connector 220 via the attachment 260.

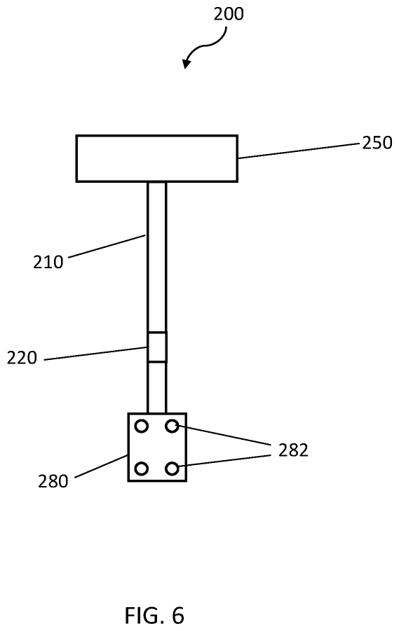

FIG. 6 shows an example front view of the second rearview mirror mount 200 (with the attachment 260 and connector 220 excluded for clarity and showing the features for connecting the shaft 210 and attachment 260). The second rearview mirror mount 200 may include a connection plate 280 (i.e., hardware for connecting the second rearview mirror mount 200 to the attachment 260) with holes 282 for screws or other similar devices to connect the connection plate 280 to the attachment 260. The connection plate 280 may include metal, plastic, and/or other durable materials suitable for securing elements together.

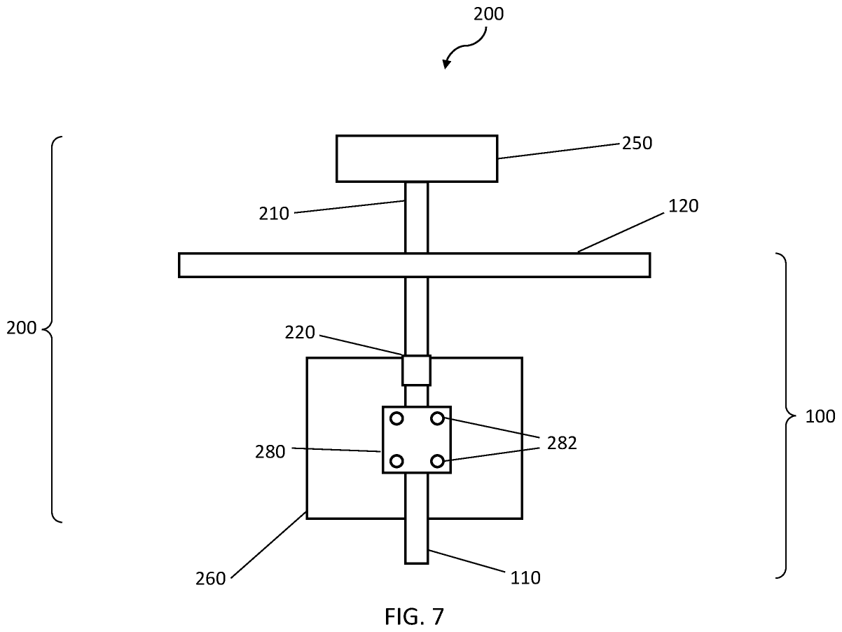

FIG. 7 shows an example front view of the second rearview mirror mount 200 attached to the attachment 260 which is attached to the steering shaft of the vehicle via the connector 220. The second rearview mirror mount 200 may be attached to the attachment 260 via screws (not shown) passing through the attachment 260 and the holes 282 in the connection plate 280.

The rearview mirror mounts 200 provide several advantages for the user of the vehicle 100 including, but not limited to, improved vision behind and around the vehicle that can be adjusted for different users or different vehicles 100 and attachments 270 such as lights, horn, camera, and other useful devices. Advantageously, in some example embodiments, the rearview mirror mounts 200 may be attached without any damage to or additional holes in the steering shaft 110.

Accordingly, the present description provides for various embodiments for a rearview mirror 250 and rearview mirror mounts 200. Many uses and advantages are offered by the rearview mirror 250 and rearview mirror mounts 200 as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A device comprising:
a shaft with a first length extending in a first direction, the first length being the greatest dimension of the shaft;
a crossbar with a second length extending in a second direction different from the first direction, the second length being the greatest dimension of the crossbar;
a mirror adjustably attached to the crossbar such that an angle of the mirror may be adjusted; and
a connector configured to attach the shaft to a steering shaft of a vehicle.

2. The device of claim 1, wherein the connector is configured to attach the shaft to the steering shaft of the vehicle through friction alone.

3. The device of claim 2, wherein the connector is an elastic clip configured to snap on the steering shaft of the vehicle.

4. The device of claim 2, wherein the connector is configured to attach the shaft to the steering shaft of the vehicle having a circular cross-section.

5. The device of claim 2, wherein the connector is configured to attach the shaft to the steering shaft of the vehicle having a rectangular cross-section.

6. The device of claim 2, wherein the connector is a latch clamp configured to tightly lock around the steering shaft of the vehicle. The device of claim 1, wherein the mirror attached to the crossbar is further configured such that a distance between the mirror and the crossbar may be adjusted.

8. The device of claim 1, further comprising:
a basket, wherein the shaft is attached to the connector via the basket.

9. The device of claim 1, further comprising:
an accessory attached to the crossbar, wherein the accessory is one of a light, horn, camera, or sensor.
